(19) United States
(12) Patent Application Publication
(10) Pub. No.: US 2023/0060623 A1
(43) Pub. Date: Mar. 2, 2023

(54) NETWORK IMPROVEMENT WITH REINFORCEMENT LEARNING

(71) Applicant: AT&T Intellectual Property I, L.P., Atlanta, GA (US)

(72) Inventors: Huahui Wang, Bridgewater, NJ (US); Wenjie Zhao, Princeton, NJ (US); Jie Chen, Watchung, NJ (US)

(21) Appl. No.: 17/410,617

(22) Filed: Aug. 24, 2021

(51) Int. Cl. H04L 12/851; H04L 12/803; H04L 12/26

(52) U.S. Cl. CPC H04L 47/2441; H04L 47/2483; H04L 47/122; H04L 43/062

(57) ABSTRACT

Intelligent, adaptive scheduling weight adjustment is enabled, e.g., to improve network performance. For instance, A non-transitory machine-readable medium can comprise executable instructions that, when executed by a processor, facilitate performance of operations, comprising based on key performance indicators corresponding to data traffic flows via a network, determining quality of service data representative of respective qualities of service for the data traffic flows, using a scheduling weight data traffic model generated using machine learning and trained using past quality of service data representative of past qualities of service of past data traffic flows via the network, from prior to the data traffic flows, and past scheduling weight settings applied to the past data traffic flows, determining a scheduling weight setting to be applied to a data traffic flow of the data traffic flows, and applying the scheduling weight setting to the data traffic flow.

### TECHNICAL FIELD

The disclosed subject matter relates to wireless networks and more particularly, to network improvement with reinforcement learning, e.g., with respect to Quality of Service of fourth generation (4G), fifth generation (5G), and sixth generation (6G) wireless networks, among others.

### BACKGROUND

Quality of Service (QoS) parameters, such as QoS class identifier (QCI) for long term evolution (LTE) or fifth generation (5G) QoS Identifier (5QI) weights, are generally used to perform service differentiation among different traffic classes. If different weights are used in a given cell, traffic associated with different QCI/5QI classes can have different priorities in a network scheduler. In practice, these parameters are predetermined, and are generally the same for all cells in the wireless networks, regardless of the traffic situation.

The above-described background relating to wireless networks is merely intended to provide a contextual overview of some current issues and is not intended to be exhaustive. Other contextual information may become further apparent upon review of the following detailed description.

### BRIEF DESCRIPTION OF DRAWINGS

FIG. 1 is a block diagram of an exemplary system in accordance with one or more embodiments described herein.

FIG. 2 is a block diagram of an exemplary system in accordance with one or more embodiments described herein.

FIG. 3 is a block diagram of an exemplary system in accordance with one or more embodiments described herein.

FIG. 4 is a block diagram of an exemplary system in accordance with one or more embodiments described herein.

FIGS. 5A and 5B depict exemplary network performance system in accordance with one or more embodiments described herein.

FIG. 6 is a flowchart for a process associated with network improvement with reinforcement learning in accordance with one or more embodiments described herein.

FIG. 7 is a flowchart for a process associated with network improvement with reinforcement learning in accordance with one or more embodiments described herein.

FIG. 8 is a block flow diagram for a process associated with network improvement with reinforcement learning in accordance with one or more embodiments described herein.

FIG. 9 is a block flow diagram for a process associated with network improvement with reinforcement learning in accordance with one or more embodiments described herein.

FIG. 10 is a block flow diagram for a process associated with network improvement with reinforcement learning in accordance with one or more embodiments described herein.

FIG. 11 is an example, non-limiting computing environment in which one or more embodiments described herein can be implemented.

FIG. 12 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As alluded to above, wireless networks can be improved in various ways, and various embodiments are described herein to this end and/or other ends.

According to an embodiment, a device can comprise: a processor, and a memory that stores executable instructions that, when executed by the processor, facilitate performance of operations, comprising: determining key performance indicators corresponding to data traffic flows via a network, wherein different quality of service classes of the data traffic flows correspond to different quality of service class identifier values, determining quality of service data representative of respective qualities of service for the data traffic flows, using a scheduling weight data traffic model generated using machine learning and trained using past quality of service data representative of past qualities of service of past data traffic flows via the network, from prior to the data traffic flows, and past scheduling weight settings applied to the past data traffic flows, determining a scheduling weight setting to be applied to a data traffic flow of the data traffic flows, wherein the scheduling weight is determined to maximize an overall network performance metric, and assigning the scheduling weight setting to be applied to the data traffic flow.

In various embodiments, the data traffic flow can be transmitted via a fourth generation communication network, and the scheduling weight setting can be associated with a quality of service class identifier value of the different quality of service class identifier values defined according to a fourth generation communication network protocol. In other embodiments, the data traffic flow can be transmitted via a fifth generation communication network, and the scheduling weight setting can be associated with a fifth generation quality of service class identifier value of the different quality of service class identifier values defined according to a fifth generation communication network protocol.

In some embodiments, the scheduling weight setting can be associated with a quality of service class identifier value of the different quality of service class identifier values defined according to a fifth generation communication network protocol, and a key performance indicator of the key performance indicators can comprise average active user devices (or arrival rate) per quality of service class identifier value of the different quality of service class identifier values. In other embodiments, the scheduling weight setting can be associated with a quality of service class identifier value of the different quality of service class identifier values defined according to a fifth generation communication network protocol, and a key performance indicator of the key performance indicators can comprise traffic volume per quality of service class identifier value of the different quality of service class identifier values. In further embodiments, the scheduling weight setting can be associated with a quality of service class identifier value of the different quality of service class identifier values defined according to a fifth generation communication network protocol, and a key performance indicator of the key performance indicators can comprise resource utilization per quality of service class identifier value of the different quality of service class identifier values. In additional embodiments, the scheduling weight setting can be associated with a quality of service class identifier value of the different quality of service class identifier values defined according to a fifth generation communication network protocol, and a key performance indicator of the key performance indicators can comprise average throughput per quality of service class identifier value of the different quality of service class identifier values.

In some embodiments, using the scheduling weight data traffic model can comprise using an output from deep reinforcement learning applied to the past quality of service data and the past scheduling weight settings. In this regard, the above operations can further comprise initializing the deep reinforcement learning comprising generating simulated data traffic flows to generate the scheduling weight data traffic model using the past data traffic flows and the past scheduling weight settings applied to the past data traffic flows.

In one or more embodiments, the scheduling weight setting can be determined, using the scheduling weight data traffic model, based on a function that increases throughput of the data traffic flow without causing other data traffic flows of the data traffic flows to be reduced below respective data traffic flow thresholds for the data traffic flows.

It is additionally noted that, in some embodiments, the overall network performance metric can comprise overall network throughput or overall sojourn time of quality of service class identifier (QCI) data flows. In other embodiments, the overall network performance metric can comprise average network latency.

In another embodiment, a non-transitory machine-readable medium cam comprise executable instructions that, when executed by a processor, facilitate performance of operations, comprising: based on key performance indicators corresponding to data traffic flows via a network, determining quality of service data representative of respective qualities of service for the data traffic flows, using a scheduling weight data traffic model generated using machine learning and trained using past quality of service data representative of past qualities of service of past data traffic flows via the network, from prior to the data traffic flows, and past scheduling weight settings applied to the past data traffic flows, determining a scheduling weight setting to be applied to a data traffic flow of the data traffic flows, and applying the scheduling weight setting to the data traffic flow. It is noted that the network can comprise a software-defined radio access network.

In one or more embodiments, the above operations can further comprise: determining whether the network is congested according to a network congestion criterion, and in response to a determination that the network is congested, throttling the data traffic flows.

In various embodiments, using the scheduling weight data traffic model can comprise using an output from an asynchronous advantage actor critic processor (or a deep-Q learning process or a multi-armed bandit process) applied to the past quality of service data and the past scheduling weight settings.

In some embodiments, the scheduling weight setting can be periodically determined according to a scheduling weight determination interval.

In yet another embodiment, a method, comprises: determining, by network equipment comprising a processor, performance indicators corresponding to data traffic transmissions via a network, wherein different quality of service classes of the data traffic transmissions correspond to different quality of service class identifier values, determining, by the network equipment, quality of service data representative of respective qualities of service for the data traffic transmissions, using, by the network equipment, a scheduling weight data traffic model generated using machine learning and trained using past quality of service data representative of past qualities of service of past data traffic transmissions via the network, from prior to the data traffic transmissions, and past scheduling weight settings applied to the past data traffic transmissions, determining a scheduling weight setting to be applied to a data traffic transmission of the data traffic transmissions, wherein the scheduling weight is determined to maximize an aggregated network performance metric, and assigning, by the network equipment, the scheduling weight setting to be applied to the data traffic transmission.

It is noted that, in some embodiments, the scheduling weight setting can be determined, by the network equipment, using the scheduling weight data traffic model, based on a function that maximizes overall network throughput of the data traffic transmission without permitting other data traffic transmissions of the data traffic transmissions to experience zero data traffic. It is noted data traffic flow thresholds other than zero data traffic can be utilized herein. In this regard, various data traffic flow rates can be utilized for such a data traffic flow threshold.

In various embodiments, the above operations can further comprise: determining, by the network equipment and using the machine learning, a network optimization policy, wherein the network optimization policy comprises the scheduling weight setting and other scheduling weight settings other than the scheduling weight setting, wherein the scheduling weight setting is associated with the key performance indicators, and wherein the other scheduling weight settings are associated with other key performance indicators other than the key performance indicators.

Embodiments herein can utilize artificial intelligence and/or machine learning to adjust network parameters in real time, such that overall network performance can be improved. Specifically, deep reinforcement learning can be utilized to adjust QoS priorities in the radio access network (RAN) scheduler to achieve optimal priority settings for best overall user throughput. The foregoing can, for instance, improve network quality and performance, reduce capital expenditures, boost revenues, and improve churn.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

It should be appreciated that additional manifestations, configurations, implementations, protocols, etc. can be utilized in connection with the following components described herein or different/additional components as would be appreciated by one skilled in the art.

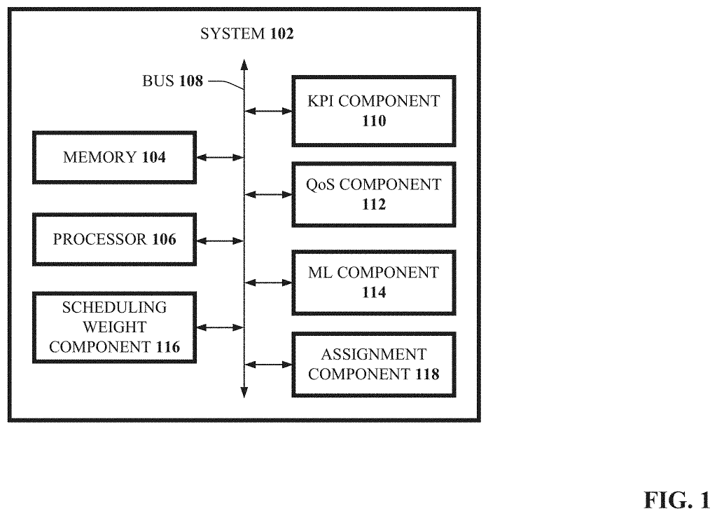

Turning now to FIG. 1, there is illustrated an example, non-limiting system 102 in accordance with one or more embodiments herein. System 102 can comprise a computerized tool, which can be configured to perform various operations relating to network (e.g., wireless network) optimization. The system 102 can comprise one or more of a variety of components, such as memory 104, processor 106, bus 108, key performance indicator (KPI) component 110, quality of service (QoS) component 112, machine learning (ML) component 114, scheduling weight component 116, and/or assignment component 118.

In various embodiments, one or more of the memory 104, processor 106, bus 108, KPI component 110, QoS component 112, ML component 114, scheduling weight component 116, and/or assignment component 118 can be communicatively or operably coupled (e.g., over a bus or wireless network) to one another to perform one or more functions of the system 102.

It is noted that the system 102 (and/or other systems later discussed herein) can comprise an eNodeB or gNodeB, or can be communicatively coupled to an eNodeB or gNodeB. In other embodiments, systems herein can comprise, or be communicatively coupled to, other network equipment. In fifth generation (5G) networks, the core network can classify incoming IP packets into quality of service (QoS) flows, based on specified rules at the packet data network gateway (P-GW) policy control function (PCF). These rules can be provided to a session management function (SMF), which can distribute session-related parameters to the entities on a user plane (UP): QoS Rules for user equipment, QoS Profiles for the gNodeB, and/or service data flow (SDF) descriptions for the user plane function (UPF). In various embodiments, networks herein can comprise software-defined radio access networks.

QoS profiles distributed that are to the gNodeB can include key parameters characterizing the QoS flow (e.g., a 5QI value). A 5G QoS Identifier (5QI) is a scalar that can be used as a reference to 5G QoS characteristics—access node-specific parameters that control QoS forwarding treatment for the QoS Flow (e.g., scheduling weights, admission thresholds, queue management thresholds, link layer protocol configuration, or other suitable parameters). Among non-guaranteed bit rate (non-GBR) traffic, different 5QI values can comprise different scheduling weights to determine their scheduling opportunities when multiple data flows are competing for transmission resources. In order to improve network performance, instead of using static weights, embodiments herein can dynamically adjust weights in an adaptive manner, based on changing network states and/or dynamically change QoS Class Identifier (QCI) priority of each QCI class (e.g., using reinforcement learning).

According to an embodiment, the KPI component 110 can determine KPIs corresponding to data traffic flows via a network. In this regard, different QoS classes of data traffic flows can correspond to different QCI values. It is noted that data traffic flows herein can be transmitted via a fourth generation (4G) communication network. In this regard, the scheduling weight setting can be associated with a QCI value of the different QCI values defined according to a 4G communication network protocol. In another embodiment, the data traffic flow can be transmitted via a 5G communication network. In this regard, the scheduling weight setting can be associated with a 5QI value of the different QCI values defined according to a 5G communication network protocol. It is noted that the overall network metric herein can comprise overall network throughput, total sojourn time (e.g., of QCI data flows), average network latency, or another suitable overall network metric.

In various embodiments herein, different QCI/5QI settings can result in varying performance under different scenarios. In this regard, instead of using these parameters for service differentiation, embodiments herein can dynamically adjust these parameters (e.g., in real time and/or individually per cell in a network) to improve the overall network performance, especially when an associated network is congested.

According to an embodiment, the QoS component 112 can determine QoS data representative of respective qualities of service for the data traffic flows. In this regard, various KPIs can be cross referenced with different QoS's.

According to an embodiment, the scheduling weight component 116 can determine a scheduling weight setting to be applied to a data traffic flow of the data traffic flows. It is noted that the scheduling weight herein can be determined to maximize (or minimize) an overall network performance metric. In various embodiments, the scheduling weight component 116 can determine the scheduling weight setting using a scheduling weight data traffic model generated machine learning (e.g., by the ML component 114) and trained using past QoS data (e.g., by the ML component 114) representative of past qualities of service of past data traffic flows via the network, from prior to the data traffic flows, and past scheduling weight settings applied to the past data traffic flows.

In another embodiment, the scheduling weight setting can be determined (e.g., by the scheduling weight component 116) using the scheduling weight data traffic model, based on a function that maximizes overall network throughput of the data traffic transmission without permitting other data traffic transmissions of the data traffic transmissions to experience zero data traffic. In other embodiments, the scheduling weight can be determined (e.g., by the scheduling weight component 116) not to cause other data traffic flows of the data traffic flows to be reduced below respective data traffic flow thresholds for the data traffic flows. In this regard, nonzero data traffic flow thresholds can be utilized.

In an additional embodiment, the scheduling weight setting herein can be periodically determined (e.g., by the scheduling weight component 116) according to a scheduling weight determination interval (e.g., one minute, ten minutes, one hour, or another suitable interval).

According to an embodiment, the scheduling weight setting can be associated with a QCI value of the different QCI values defined according to a 5G communication network protocol. In this regard, a KPI of the KPIs can comprise average active user devices (or the arrival rate) per 5QI/QCI value of the different 5QI/QCI values. In other embodiments, the KPI of the KPIs can comprise resource utilization per 5QI/QCI value of the different 5QI/QCI values. In further embodiments, the KPI of the KPIs can comprise average throughput per 5QI/QCI value of the different 5QI/QCI values. Additionally, the KPI of the KPIs can comprise traffic volume (e.g., bits) per 5QI/QCI value of the different 5QI/QCI values.

In various embodiments, QCI weights can be prevented from decreasing network performance by more than a defined threshold amount. In this regard, a defined minimum threshold for network performance (e.g., throughput, latency, or another suitable metric) can be maintained for each respective QCI value. For example, QCI8 can be weighted lower than QCI9, but QCI8 can still be prevented from exhibiting network performance below a defined threshold value. In another example, if QCI8 is associated with non-GBR traffic, the traffic associated with QCI8 can be prevented from falling below a defined usable threshold data traffic throughput.

In one or more embodiments, using the scheduling weight data traffic model can comprise using an output from deep reinforcement learning applied to the past QoS data and the past scheduling weight settings.

According to an embodiment, the ML component 114 can initialize the deep reinforcement learning comprising generating simulated data traffic flows to generate the scheduling weight data traffic model using the past data traffic flows and the past scheduling weight settings applied to the past data traffic flows. It is noted that the ML component 114 can utilize one or more of various ML techniques, such as deep-Q learning (e.g., with discrete values), deep deterministic policy gradient (DDPG) (e.g., with continues values), asynchronous advantage actor critic (A3C), advantage actor critic (A2C), multi-armed bandit (MAB), or other suitable learning techniques as later discussed in greater detail. It is noted that the ML component 114 can leverage a deep neural network with various suitable layers and/or parameters.

In another embodiment, using the scheduling weight data traffic model can comprise using an output from an asynchronous advantage actor critic process applied to the past QoS data and the past scheduling weight settings. In other embodiments, the output can be from a deep-Q learning process or a multi-armed bandit process.

Various embodiments herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or machine learning components herein can comprise artificial intelligence component(s) which can employ an artificial intelligence (AI) model and/or machine learning (ML) or a machine learning model that can learn to perform the above or below described functions (e.g., via training using historical training data and/or feedback data).

In some embodiments, ML component 114 can comprise an AI and/or ML model that can be trained (e.g., via supervised and/or unsupervised techniques) to perform the above or below-described functions using historical training data comprising various context conditions that correspond to various augmented network optimization operations. In this example, such an AI and/or ML model can further learn (e.g., via supervised and/or unsupervised techniques) to perform the above or below-described functions using training data comprising feedback data, where such feedback data can be collected and/or stored (e.g., in memory) by the ML component 114. In this example, such feedback data can comprise the various instructions described above/below that can be input, for instance, to a system herein, over time in response to observed/stored context-based information.

AI/ML components herein can initiate an operation(s) associated with a based on a defined level of confidence determined using information (e.g., feedback data). For example, based on learning to perform such functions described above using feedback data, performance information, and/or past performance information herein, an ML component 114 herein can initiate an operation associated with determining various thresholds herein (e.g., a data traffic flow threshold).

In an embodiment, the ML component 114 can perform a utility-based analysis that factors cost of initiating the above-described operations versus benefit. In this embodiment, the ML component 114 can use one or more additional context conditions to determine various thresholds herein.

To facilitate the above-described functions, a ML component 114 herein can perform classifications, correlations, inferences, and/or expressions associated with principles of artificial intelligence. For instance, the ML component 114 can employ an automatic classification system and/or an automatic classification. In one example, the ML component 114 can employ a probabilistic and/or statistical-based analysis (e.g., factoring into the analysis utilities and costs) to learn and/or generate inferences. The ML component 114 can employ any suitable machine-learning based techniques, statistical-based techniques and/or probabilistic-based techniques. For example, the ML component 114 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the ML component 114 can perform a set of machine-learning computations. For instance, the ML component 114 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

In one or more embodiments, the scheduling weight setting can be determined, using the scheduling weight data traffic model, based on a function that increases throughput of the data traffic flow without causing other data traffic flows of the data traffic flows to be reduced below respective data traffic flow thresholds for the data traffic flows.

According to an embodiment, the assignment component 118 can assign the scheduling weight setting to be applied to the data traffic flow.

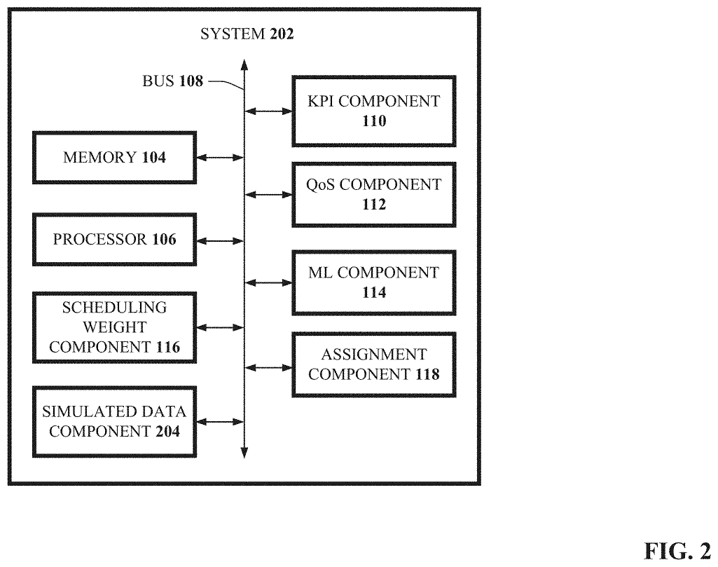

Turning now to FIG. 2, there is illustrated an example, non-limiting system 202 in accordance with one or more embodiments herein. System 202 can comprise a computerized tool, which can be configured to perform various operations relating to network optimization. The system 202 can be similar to system 102, and can comprise one or more of a variety of components, such as memory 104, processor 106, bus 108, KPI component 110, QoS component 112, ML component 114, scheduling weight component 116, and/or assignment component 118. The system 202 can additionally comprise a simulated data component 204.

In various embodiments, one or more of the memory 104, processor 106, bus 108, KPI component 110, QoS component 112, ML component 114, scheduling weight component 116, assignment component 118, and/or simulated data component 204 can be communicatively or operably coupled (e.g., over a bus or wireless network) to one another to perform one or more functions of the system 202.

According to an embodiment, the simulated data component 204 can initialize deep reinforcement learning by generating simulated data traffic flows to generate the scheduling weight data traffic model using the past data traffic flows and the past scheduling weight settings applied to the past data traffic flows. In this regard, such simulated data can be generated in order to increase accuracy of the scheduling weight data traffic model described herein. It is noted that such simulated data can comprise augmented data (e.g., fuzzy data or fuzzy sets of data), which can be generated using random generation or generated (e.g., by the simulated data component 204 and/or ML component 114) according to a defined augmented data generation function. In other embodiments, the simulated data can comprise randomly modified historical data.

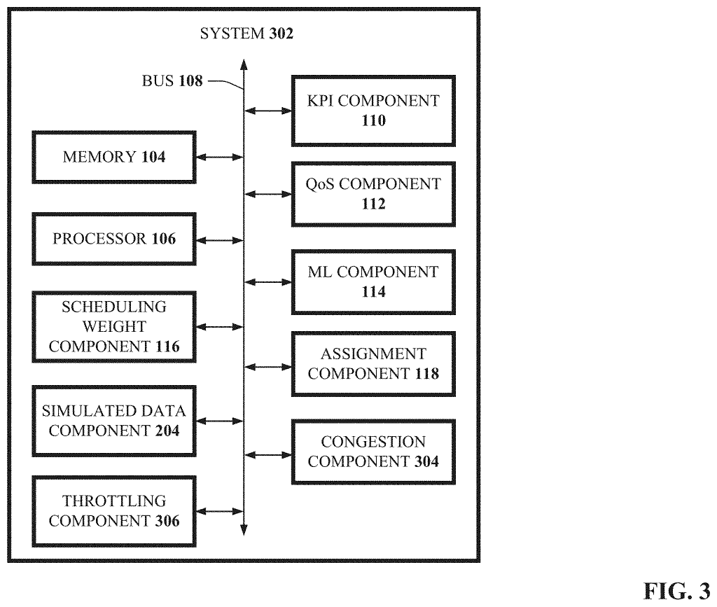

With reference to FIG. 3, there is illustrated an example, non-limiting system 302 in accordance with one or more embodiments herein. System 302 can comprise a computerized tool, which can be configured to perform various operations relating to network optimization. The system 302 can be similar to system 202, and can comprise one or more of a variety of components, such as memory 104, processor 106, bus 108, KPI component 110, QoS component 112, ML component 114, scheduling weight component 116, assignment component 118, and/or simulated data component 204. The system 302 can additionally comprise a congestion component 304 and/or a throttling component 306.

In various embodiments, one or more of the memory 104, processor 106, bus 108, KPI component 110, QoS component 112, ML component 114, scheduling weight component 116, assignment component 118, simulated data component 204, congestion component 304, and/or throttling component 306 can be communicatively or operably coupled (e.g., over a bus or wireless network) to one another to perform one or more functions of the system 302.

According to an embodiment, the congestion component 304 can determine whether the network is congested according to a network congestion criterion. In this regard, the congestion component 304 can, for instance, determine if/when QoS is reduced below (or above) a threshold throughput, queueing delay, packet loss, blocking of new connections, latency, or another suitable threshold metric or threshold.

According to an embodiment, the throttling component 306 can throttle data traffic flows (e.g., in response to a determination by the congestion component 304 that the network is congested). In this regard, the throttling component 306 can perform bandwidth throttling by intentionally slowing (or speeding) data flows associated with the system 302.

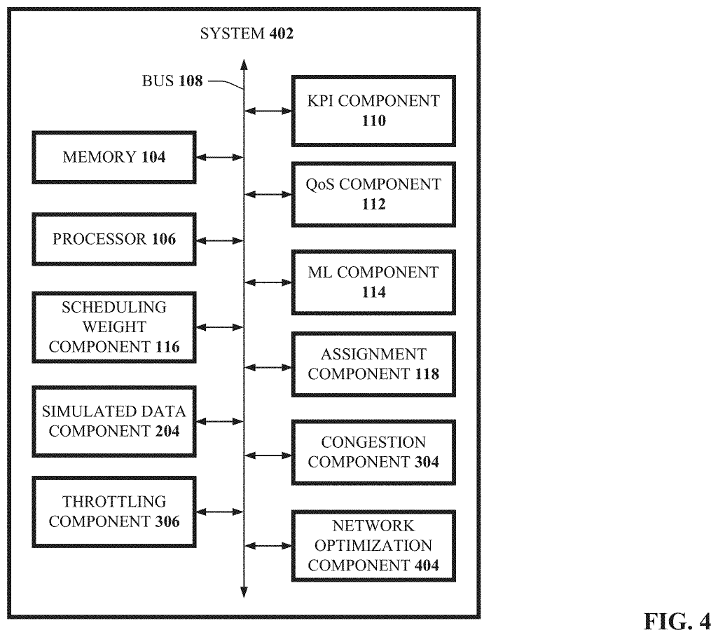

With reference to FIG. 4, there is illustrated an example, non-limiting system 402 in accordance with one or more embodiments herein. System 402 can comprise a computerized tool, which can be configured to perform various operations relating to network optimization. The system 402 can be similar to system 302, and can comprise one or more of a variety of components, such as memory 104, processor 106, bus 108, KPI component 110, QoS component 112, ML component 114, scheduling weight component 116, assignment component 118, and/or simulated data component 204, congestion component 304 and/or throttling component 306. The system 402 can additionally comprise a network optimization component 404.

In various embodiments, one or more of the memory 104, processor 106, bus 108, KPI component 110, QoS component 112, ML component 114, scheduling weight component 116, assignment component 118, simulated data component 204, congestion component 304, throttling component 306, and/or network optimization component 404 can be communicatively or operably coupled (e.g., over a bus or wireless network) to one another to perform one or more functions of the system 402.

According to an embodiment, the network optimization component 404 can determine (e.g., using the ML component 114) a network optimization policy. In this regard, the network optimization policy herein can comprise the scheduling weight setting and other scheduling weight settings other than the scheduling weight setting. Further in this regard, a scheduling weight setting herein can be associated with the KPIs, and the other scheduling weight settings can be associated with other KPIs other than the KPIs. In various embodiments, the network optimization component 404 can determine optimal QCI or 5QI weights under various conditions and/or contexts. For instance, optimal QCI or 5QI weights vary depending on time of day, geographic, meteorological, or atmospheric conditions, device type(s), quantity of devices, and/or other suitable conditions.

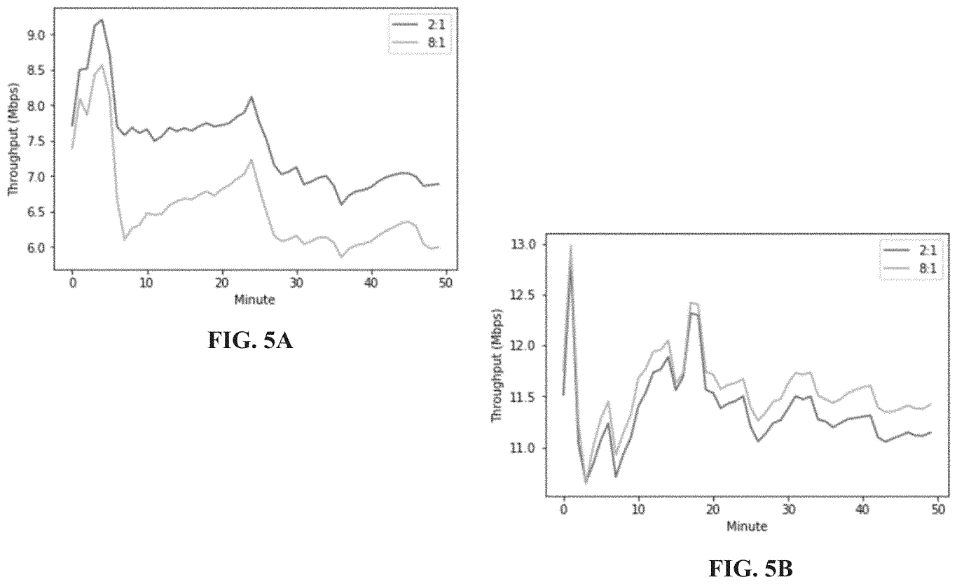

With reference to FIGS. 5A and 5B, there are illustrated exemplary network performance diagrams in accordance with one or more embodiments described herein. Overall network throughput can improve or degrade depending on the traffic characteristics of different QCI classes. Stated otherwise, the setting of 5QI weights can impact overall network performance. Exemplary FIGS. 5A and 5B illustrate that, in one nonlimiting, exemplary case, increasing the 5QI8:5QI9 weight ratio from 2:1 to 8:1 degrades the throughput by 14% (e.g., FIG. 5A). In another nonlimiting, exemplary case, the same can weight ratios improve throughput 3% (FIG. 5B). Therefore, for optimal network performance, scheduling weights among different classes can be dynamically set. It is noted that different settings can be changed at different times. In this regard, weights can be dynamically changed based on a variety of suitable variables, contexts, and/or conditions for throughput optimization.

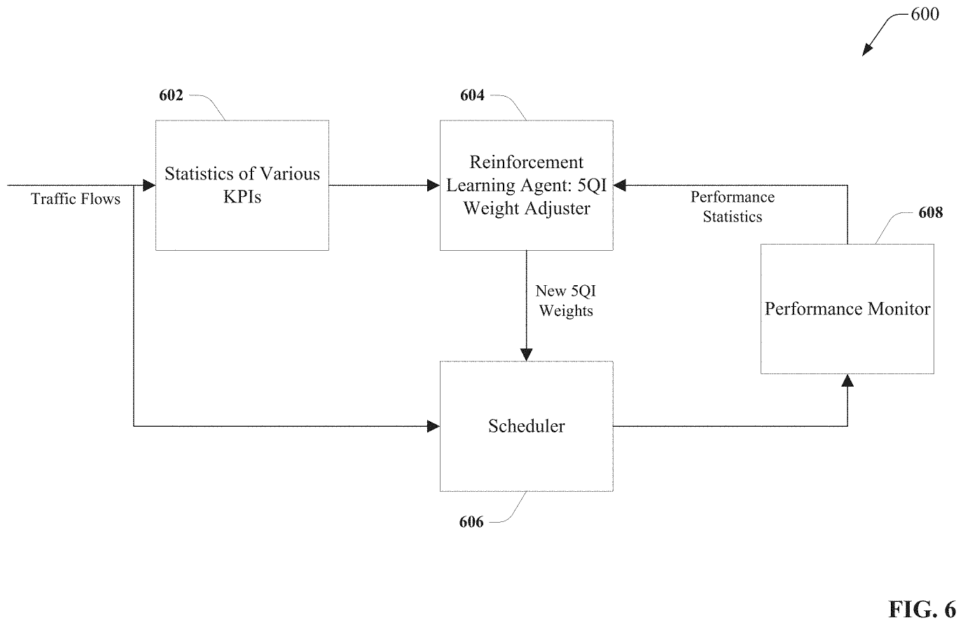

Turning now to FIG. 6, there is illustrated a flowchart for a process 600 associated with network improvement with reinforcement learning in accordance with one or more embodiments described herein. At 602, various KPI statistics of various data traffic flows can be monitored (e.g., by the KPI component 110). It is noted that such KPIs herein can comprise numbers of users, packet loss, jitter, traffic volume (e.g., number of bits), active users, throughput, waiting time, latency, or other suitable metrics/KPIs. At 604, 5QI weights (e.g., optimal 5QI weights) can be determined (e.g., by the scheduling weight component 116 using the ML component 114). At 606, the 5QI weights can be provided to a scheduler (e.g., assignment component 118) in order to adjust resource allocation for the data traffic flows. At 608, performance can be monitored (e.g., by a network optimization component 404) for use in 5QI weight improvement and/or network planning. It is noted that network performance herein is generally measured using throughput, sojourn time, or latency, though other suitable performance metrics can be utilized. In this regard, observed network performance can be utilized for improvement of assignment of weights and/or resource allocation. It is noted that the foregoing can be performed, for instance, according to a time interval (e.g., every one minute, every ten minutes, every hour, or at another suitable interval).

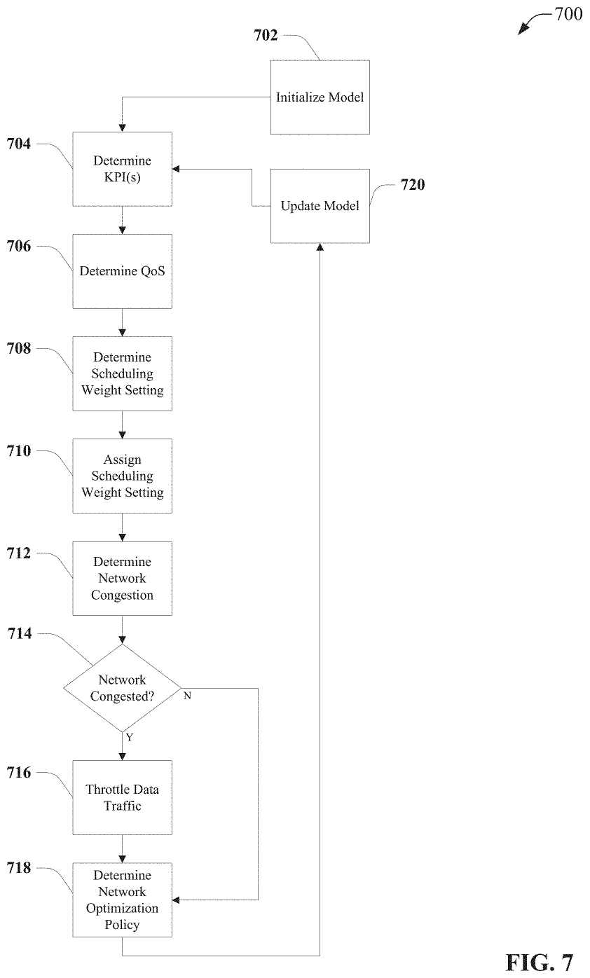

Turning now to FIG. 7, there is illustrated a flow chart of a process 700 relating to network optimization in accordance with one or more embodiments described herein. At 702, a model (e.g., a scheduling weight data traffic model) can be initialized (e.g., by a network optimization component 404). This can be performed by generating (e.g., by the simulated data component 204) simulated data traffic flows to generate the scheduling weight data traffic model (e.g., using the ML component 114) using the past data traffic flows and the past scheduling weight settings applied to the past data traffic flows. At 704, KPIs (numbers of users, packet loss, jitter, traffic volume (e.g., number of bits), active users, throughput, waiting time, latency, or other suitable metrics/KPIs) can be determined (e.g., using the KPI component 110). At 706, QoS data representative of respective qualities of service for the data traffic flows can be determined (e.g., by the QoS component 112). At 708, a scheduling weight setting can be determined (e.g., by the scheduling weight component 116). It is noted that the scheduling weight can be determined to maximize an overall network performance metric. In various embodiments, the scheduling weight component 116 can determine the scheduling weight setting using an output from machine learning and trained using past QoS data (e.g., by the ML component 114) representative of past qualities of service of past data traffic flows via the network, from prior to the data traffic flows, and past scheduling weight settings applied to the past data traffic flows. In another embodiment, the scheduling weight setting can be determined by the scheduling weight component 116 using the scheduling weight data traffic model, based on a function that maximizes overall network throughput of the data traffic transmission without causing other data traffic flows of the data traffic flows to be reduced below respective data traffic flow thresholds for the data traffic flows. According to an example, the data traffic flow threshold can be a zero or nonzero data traffic flow threshold. In an additional embodiment, the scheduling weight setting can be periodically determined (e.g., by the scheduling weight component 116) according to a scheduling weight determination interval. According to an embodiment, the scheduling weight setting can be associated with a QCI value of the different QCI values defined according to a 5G communication network protocol. In this regard, a KPI of the KPIs can comprise average active user devices (or arrival rate) per 5QI/QCI value of the different 5QI/QCI values. In other embodiments, the KPI of the KPIs can comprise resource utilization per 5QI/QCI value of the different 5QI/QCI values. In further embodiments, the KPI of the KPIs can comprise average throughput per 5QI/QCI value of the different 5QI/QCI values. Additionally, the KPI of the KPIs can comprise traffic volume (e.g., bits) per 5QI/QCI value of the different 5QI/QCI values. At 710, the determined scheduling weight setting can be assigned and/or applied (e.g., by the assignment component 118). At 712, network congestion can be determined (e.g., by the congestion component 304). In this regard, the congestion component 304 can determine whether network performance is suffering (e.g., as a result of too many users, too much data consumed, or caused by other factors). At 714, if the network is not congested (N at 714), the process can proceed to 718. If at 714, the network is congested (Y at 714), the process can proceed to 716. At 716, data traffic flow(s) across the network can be throttled (e.g., by the throttling component 306). At 718, a network optimization policy can be determined (e.g., by the network optimization component 404). In this regard, the network optimization policy can comprise the scheduling weight setting and other scheduling weight settings other than the scheduling weight setting. Further in this regard, the scheduling weight setting can be associated with the KPIs, and the other scheduling weight settings can be associated with other KPIs other than the KPIs. At 720, the data traffic model can be updated (e.g., using the ML component 114 and/or network optimization component 404).

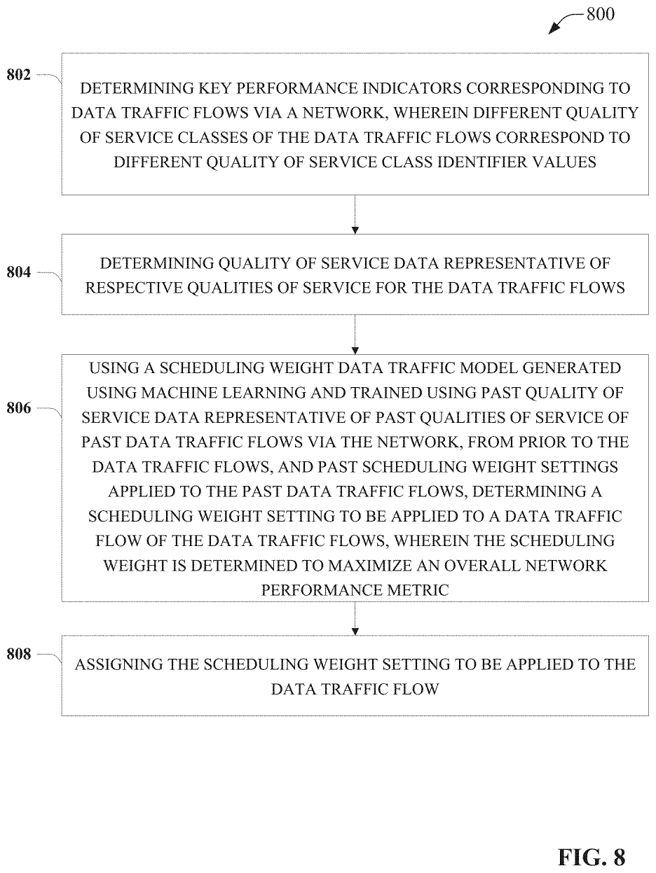

FIG. 8 illustrates a block flow diagram for a process 800 associated with network optimization in accordance with one or more embodiments described herein. At 802, the process 800 can comprise: determining (e.g., using the KPI component 110) key performance indicators corresponding to data traffic flows via a network, wherein different quality of service classes of the data traffic flows correspond to different quality of service class identifier values. At 804, the process 800 can comprise: determining (e.g., using the QoS component 112) quality of service data representative of respective qualities of service for the data traffic flows. At 806, the process 800 can comprise: using a scheduling weight data traffic model generated using machine learning and trained (e.g., by the ML component 114) using past quality of service data representative of past qualities of service of past data traffic flows via the network, from prior to the data traffic flows, and past scheduling weight settings applied to the past data traffic flows, determining (e.g., using the scheduling weight component 116) a scheduling weight setting to be applied to a data traffic flow of the data traffic flows, wherein the scheduling weight is determined to maximize an overall network performance metric. At 808, the process 800 can comprise: assigning (e.g., using the assignment component 118) the scheduling weight setting to be applied to the data traffic flow.

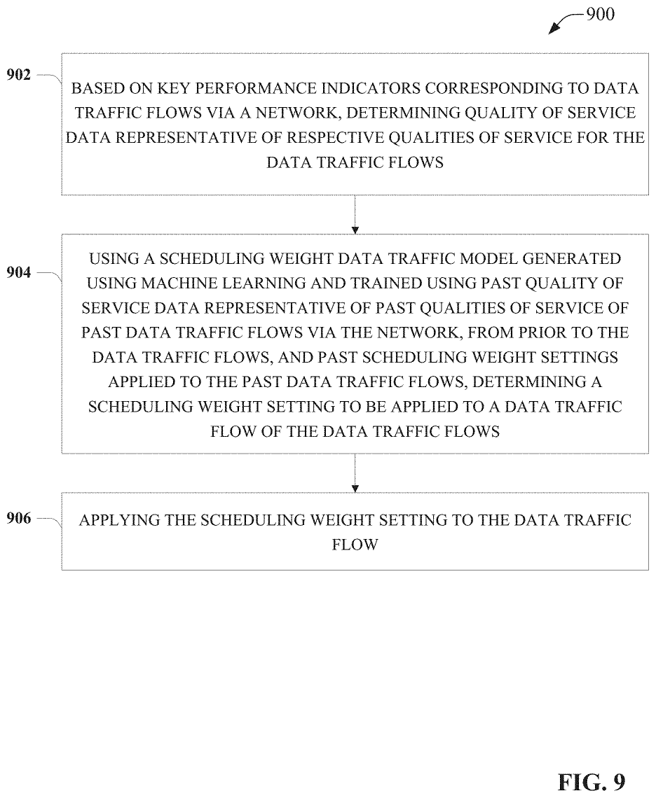

FIG. 9 illustrates a block flow diagram for a process 900 associated with network optimization in accordance with one or more embodiments described herein. At 902, the process 900 can comprise: based on key performance indicators corresponding to data traffic flows via a network, determining (e.g., using the KPI component 110) quality of service data representative of respective qualities of service for the data traffic flows. At 904, the process 900 can comprise: using a scheduling weight data traffic model generated using machine learning (e.g., using the ML component 114) and trained using past quality of service data representative of past qualities of service of past data traffic flows via the network, from prior to the data traffic flows, and past scheduling weight settings applied to the past data traffic flows, determining (e.g., using the scheduling weight component 204) a scheduling weight setting to be applied to a data traffic flow of the data traffic flows. At 906, the process 900 can comprise: applying (e.g., using the assignment component 118) the scheduling weight setting to the data traffic flow.

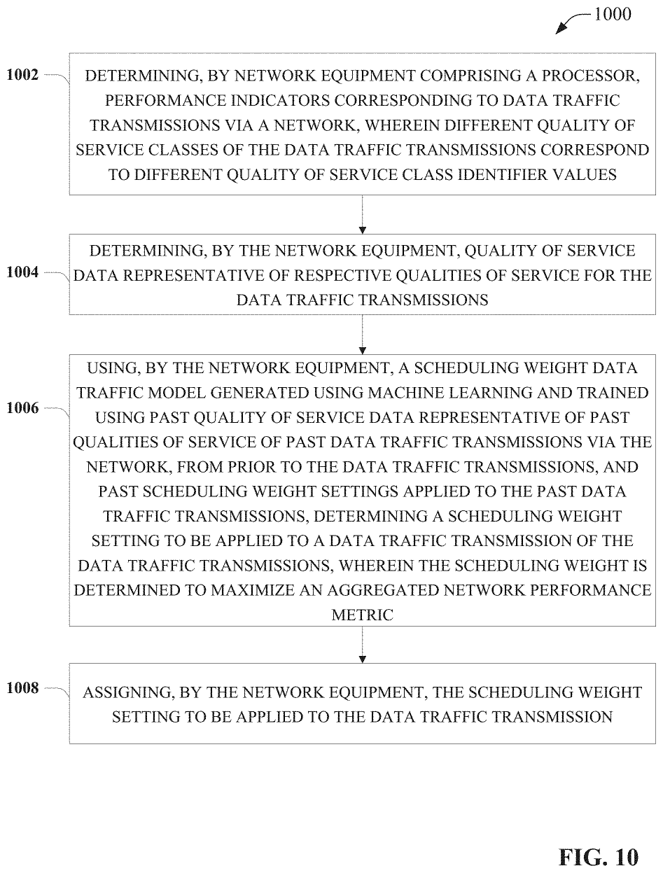

FIG. 10 illustrates a block flow diagram for a process 1000 associated with network optimization in accordance with one or more embodiments described herein. At 1002, the process 1000 can comprise: determining, by network equipment comprising a processor (e.g., using the KPI component 110), performance indicators corresponding to data traffic transmissions via a network, wherein different quality of service classes of the data traffic transmissions correspond to different quality of service class identifier values. At 1004, the process 1000 can comprise: determining, by the network equipment (e.g., using the QoS component 112), quality of service data representative of respective qualities of service for the data traffic transmissions. At 1006, the process 1000 can comprise: using, by the network equipment (e.g., with ML component 114), a scheduling weight data traffic model generated using machine learning and trained using past quality of service data representative of past qualities of service of past data traffic transmissions via the network, from prior to the data traffic transmissions, and past scheduling weight settings applied to the past data traffic transmissions, determining (e.g., using the scheduling weight component 116) a scheduling weight setting to be applied to a data traffic transmission of the data traffic transmissions, wherein the scheduling weight is determined to maximize an aggregated network performance metric. At 1008, the process 1000 can comprise: assigning, by the network equipment (e.g., using the assignment component 118), the scheduling weight setting to be applied to the data traffic transmission.

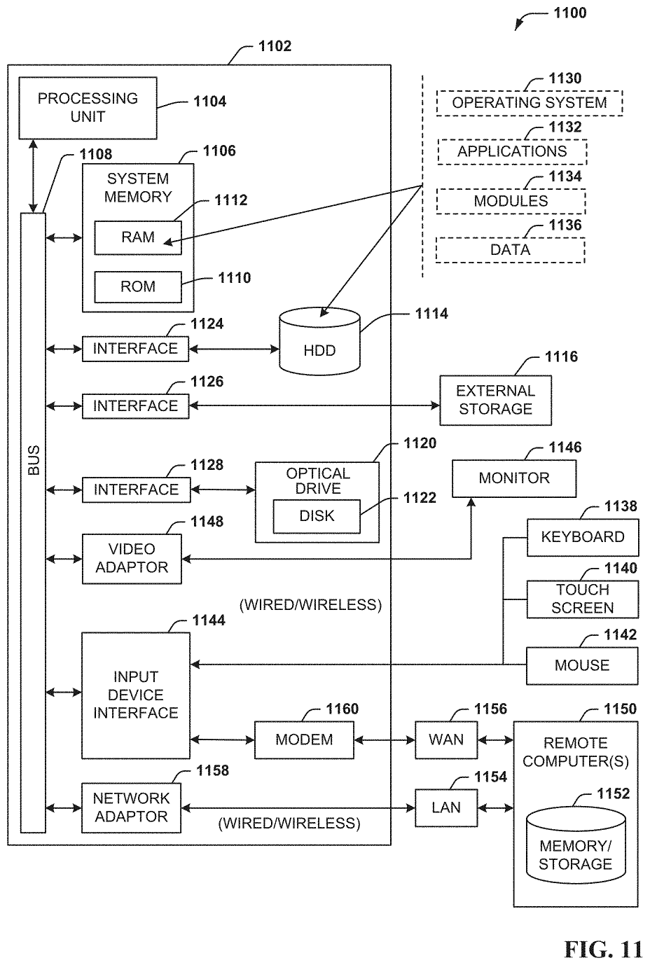

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid-state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enable with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

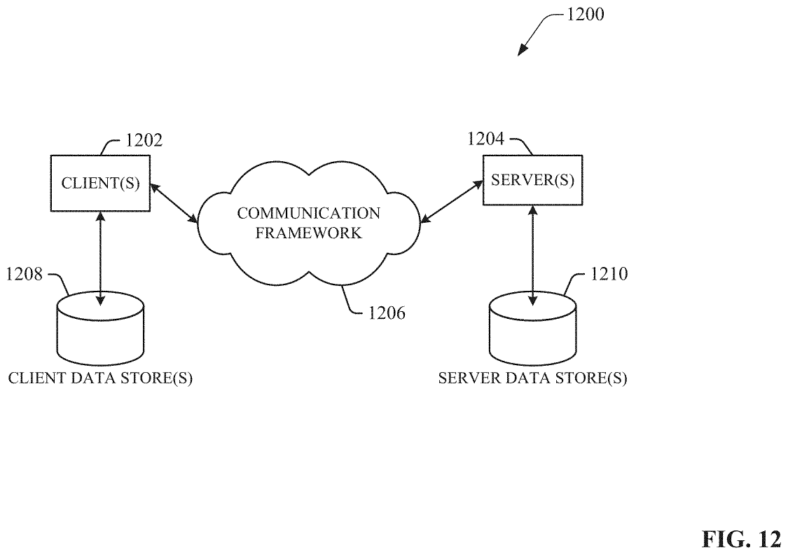

Referring now to FIG. 12, there is illustrated a schematic block diagram of a computing environment 1200 in accordance with this specification. The system 1200 includes one or more client(s) 1202, (e.g., computers, smart phones, tablets, cameras, PDA's). The client(s) 1202 can be hardware and/or software (e.g., threads, processes, computing devices). The client(s) 1202 can house cookie(s) and/or associated contextual information by employing the specification, for example.

The system 1200 also includes one or more server(s) 1204. The server(s) 1204 can also be hardware or hardware in combination with software (e.g., threads, processes, computing devices). The servers 1204 can house threads to perform transformations of media items by employing aspects of this disclosure, for example. One possible communication between a client 1202 and a server 1204 can be in the form of a data packet adapted to be transmitted between two or more computer processes wherein data packets may include coded analyzed headspaces and/or input. The data packet can include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

In one exemplary implementation, a client 1202 can transfer an encoded file, (e.g., encoded media item), to server 1204. Server 1204 can store the file, decode the file, or transmit the file to another client 1202. It is noted that a client 1202 can also transfer uncompressed file to a server 1204 and server 1204 can compress the file and/or transform the file in accordance with this disclosure. Likewise, server 1204 can encode information and transmit the information via communication framework 1206 to one or more clients 1202.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A system, comprising:
a processor; and
a memory that stores executable instructions that, when executed by the processor, facilitate performance of operations, comprising:
determining key performance indicators corresponding to data traffic flows via a network, wherein different quality of service classes of the data traffic flows correspond to different quality of service class identifier values;
based on the key performance indicators, determining quality of service data representative of respective qualities of service for the data traffic flows;
using a scheduling weight data traffic model generated using machine learning and trained using past quality of service data representative of past qualities of service of past data traffic flows via the network, from prior to the data traffic flows, and past scheduling weight settings applied to the past data traffic flows, determining a scheduling weight setting to be applied to a data traffic flow of the data traffic flows, wherein the scheduling weight setting is determined to maximize an overall network performance metric; and
assigning the scheduling weight setting to be applied to the data traffic flow.

2. The system of claim 1, wherein the data traffic flow is transmitted via a fourth generation communication network, and wherein the scheduling weight setting is associated with a quality of service class identifier value of the different quality of service class identifier values defined according to a fourth generation communication network protocol.

3. The system of claim 1, wherein the data traffic flow is transmitted via a fifth generation communication network, and wherein the scheduling weight setting is associated with a fifth generation quality of service class identifier value of the different quality of service class identifier values defined according to a fifth generation communication network protocol.

4. The system of claim 1, wherein the scheduling weight setting is associated with a quality of service class identifier value of the different quality of service class identifier values defined according to a fifth generation communication network protocol, and wherein a key performance indicator of the key performance indicators comprises average active user devices per quality of service class identifier value of the different quality of service class identifier values.

5. The system of claim 1, wherein the scheduling weight setting is associated with a quality of service class identifier value of the different quality of service class identifier values defined according to a fifth generation communication network protocol, and wherein a key performance indicator of the key performance indicators comprises traffic volume per quality of service class identifier value of the different quality of service class identifier values.

6. The system of claim 1, wherein the scheduling weight setting is associated with a quality of service class identifier value of the different quality of service class identifier values defined according to a fifth generation communication network protocol, and wherein a key performance indicator of the key performance indicators comprises resource utilization per quality of service class identifier value of the different quality of service class identifier values.

7. The system of claim 1, wherein the scheduling weight setting is associated with a quality of service class identifier value of the different quality of service class identifier values defined according to a fifth generation communication network protocol, and wherein a key performance indicator of the key performance indicators comprises average throughput per quality of service class identifier value of the different quality of service class identifier values.

8. The system of claim 1, wherein using the scheduling weight data traffic model comprises using an output from deep reinforcement learning applied to the past quality of service data and the past scheduling weight settings.

9. The system of claim 8, wherein the operations further comprise:
initializing the deep reinforcement learning comprising generating simulated data traffic flows to generate the scheduling weight data traffic model using the past data traffic flows and the past scheduling weight settings applied to the past data traffic flows.

10. The system of claim 1, wherein the scheduling weight setting is determined, using the scheduling weight data traffic model, based on a function that increases throughput of the data traffic flow without causing other data traffic flows of the data traffic flows to be reduced below respective data traffic flow thresholds for the data traffic flows.

11. The system of claim 1, wherein the overall network performance metric comprises overall network throughput.

12. The system of claim 1, wherein the overall network performance metric comprises average network latency.

13. A non-transitory machine-readable medium, comprising executable instructions that, when executed by a processor, facilitate performance of operations, comprising:
based on key performance indicators corresponding to data traffic flows via a network, determining quality of service data representative of respective qualities of service for the data traffic flows;
using a scheduling weight data traffic model generated using machine learning and trained using past quality of service data representative of past qualities of service of past data traffic flows via the network, from prior to the data traffic flows, and past scheduling weight settings applied to the past data traffic flows, determining a scheduling weight setting to be applied to a data traffic flow of the data traffic flows; and
applying the scheduling weight setting to the data traffic flow.

14. The non-transitory machine-readable medium of claim 13, wherein the network comprises a software-defined radio access network.

15. The non-transitory machine-readable medium of claim 13, wherein the operations further comprise:
determining whether the network is congested according to a network congestion criterion; and
in response to a determination that the network is congested, throttling the data traffic flows.

16. The non-transitory machine-readable medium of claim 13, wherein using the scheduling weight data traffic model comprises using an output from an asynchronous advantage actor critic process applied to the past quality of service data and the past scheduling weight settings.

17. The non-transitory machine-readable medium of claim 13, wherein the scheduling weight setting is periodically determined according to a scheduling weight determination interval.

18. A method, comprising:
determining, by network equipment comprising a processor, performance indicators corresponding to data traffic transmissions via a network, wherein different quality of service classes of the data traffic transmissions correspond to different quality of service class identifier values;
based on the performance indicators, determining, by the network equipment, quality of service data representative of respective qualities of service for the data traffic transmissions;
using, by the network equipment, a scheduling weight data traffic model generated using machine learning and trained using past quality of service data representative of past qualities of service of past data traffic transmissions via the network, from prior to the data traffic transmissions, and past scheduling weight settings applied to the past data traffic transmissions, determining a scheduling weight setting to be applied to a data traffic transmission of the data traffic transmissions, wherein the scheduling weight setting is determined to maximize an aggregated network performance metric; and
assigning, by the network equipment, the scheduling weight setting to be applied to the data traffic transmission.

19. The method of claim 18, wherein the scheduling weight setting is determined, by the network equipment, using the scheduling weight data traffic model, based on a function that maximizes overall network throughput of the data traffic transmission without permitting other data traffic transmissions of the data traffic transmissions to experience zero data traffic.

20. The method of claim 18, further comprising:
determining, by the network equipment and using the machine learning, a network optimization policy, wherein the network optimization policy comprises the scheduling weight setting and other scheduling weight settings other than the scheduling weight setting, wherein the scheduling weight setting is associated with the key performance indicators, and wherein the other scheduling weight settings are associated with other key performance indicators other than the key performance indicators.
